(19) United States
(12) Patent Application Publication
(10) Pub. No.: US 2015/0059088 A1
(43) Pub. Date: Mar. 5, 2015

(54) Pivotable Joint and Infant Support Structure Including the Same

(71) Applicant: Mattel, Inc., El Segundo, CA (US)

(72) Inventor: Matthew Alan Szymanski, East Aurora, NY (US)

(21) Appl. No.: 14/253,117

(22) Filed: Apr. 15, 2014

Related U.S. Application Data
(63) Continuation of application No. PCT/US2013/057219, filed on Aug. 29, 2013.

(51) Int. Cl. A47D 9/00; F16C 11/04

(52) U.S. Cl. CPC A47D 9/005; F16C 11/04
USPC 5/99.1; 403/119; 29/525.01

(57) ABSTRACT

An infant support structure with a pivotable joint includes a frame, a child receiving portion, and a pivotable joint. The pivotable joint is fixedly coupled to both the frame and the child receiving portion and configured to pivotally couple the child receiving portion such that the infant support structure is movable between an extended configuration and a storage configuration. The pivotable joint includes an insert that is rotatably mounted within a sleeve and configured to receive fasteners through the sleeve, such that the insert may be fixedly coupled to a portion of an infant support structure while remaining rotatably coupled to the sleeve.

### CROSS-REFERENCE TO RELATED APPLICATION

The present application is a continuation of International Patent Application PCT/US2013/057219, filed Aug. 29, 2013, entitled “Pivotable Joint and Infant Support Structure Including the Same,” Attorney Docket No. 0643.2137i, the entire disclosure of which is incorporated by reference herein in its entirety.

### FIELD OF THE INVENTION

The present invention relates to a joint, and in particular, to a joint that may rotatably or pivotably secure an item to a frame. More specifically, the present invention relates to a joint that can pivotably couple an infant support structure to a tubular frame.

### BACKGROUND OF THE INVENTION

Parents have available to them a myriad of infant support devices. For example, infant mats or gyms are easily portable, and provide an infant with a comfortable, sanitary place to rest. While infant mats can be easily packed away into a car or a diaper bag, such supports cannot be rocked or otherwise manipulated to soothe and pacify the infant. However, alternative support devices, such as bassinets and cradles, are typically not easily to collapsed for storage or transport. Furthermore, conventional bassinets are not capable of being rocked and, while sturdy, are often expensive, especially when considering that they are generally only used during the first few months of an infant's life. As a result, strollers are often used as makeshift cribs when away from home. While many strollers can be quickly collapsed and stored in the trunk or back seat of a car, they are generally not recommended for use with very small infants as a portable crib or cradle because the seat portion may not offer adequate support for the infant's back and neck.

In order to remedy the aforementioned issues, some foldable or collapsible infant support structures have been provided, but many of these infant support structures are only foldable or collapsible insofar as their frames include foldable or collapsible legs. Thus, it would be desirable to provide a joint for an infant support structure that allows the infant support structure to quickly and easily fold upon its frame such that a portable, secure infant support structure is provided.

### SUMMARY OF THE INVENTION

Generally, an infant support structure with a pivotable joint includes a frame, a child receiving portion, and a pivotable joint. The pivotable joint is coupled to both the frame and the child receiving portion and configured to pivotally couple the child receiving portion to the frame such that the infant support structure is movable between an extended configuration and a storage configuration.

According to one exemplary embodiment, a pivotable joint for an infant support structure includes an insert fixedly coupleable to a first portion of an infant support structure, a sleeve including a first engagement portion and a second engagement portion, and a fastener configured to couple the insert to the first portion of the infant support structure. The sleeve is fixedly coupled to a second portion of the infant support structure via the first engagement portion and the insert is rotatably mounted within the second engagement portion. Additionally, the fastener is disposed entirely interiorly of the second engagement portion. In some embodiments of the above pivotable joint, the infant support structure is a bassinet and the pivotable joint allows the bassinet to move between an expanded configuration and a folded configuration.

In other embodiments of the above pivotable joint, the insert comprises an annular cylinder including at least one aperture formed in the outer surface of the annular cylinder. In some of these embodiments, the annular cylinder includes exterior ribs and the ribs are configured to space the insert from the sleeve while allowing the insert and sleeve to rotate with respect to each other. In others, the annular cylinder is formed from a first portion and a second portion configured to be mated together.

In some embodiments where the annular cylinder is formed from a first portion and a second portion, the second engagement portion includes an interior opening, the first portion includes a first base, and the second portion includes a second base. In these embodiments, the first base is configured to extend beyond the periphery of the interior opening at a first end of the interior opening and the second base is configured to extend beyond the periphery of the interior opening at a second end of the interior opening to longitudinally secure the insert within the sleeve. In other embodiments, the first portion includes at least one of the at least one aperture, the second portion includes at least one of the least one apertures and the apertures are configured to be linearly aligned when the first portion is mated to the second portion.

In still further embodiments where the insert comprises an annular cylinder including at least one aperture formed in the outer surface of the annular cylinder, the second engagement portion includes at least one radial aperture and the radial aperture is selectively alignable with at least one of the at least one aperture included on the insert to allow the fastener to pass through the sleeve and engage the insert. In some of these embodiments, the diameter of the at least one aperture included on the insert is less than the diameter of the radial aperture such that the fastener may pass through the radial aperture but be retained in the aperture.

According to the present invention, a method of installing the above pivotable joint onto an infant support structure may include: inserting the first portion of the insert into a first end of the second engagement portion of the sleeve; inserting the second portion of the insert into a second end of the second engagement portion of the sleeve; mating the first portion to the second portion; inserting the first portion of the infant support structure through the insert; coupling the insert to the first portion of the infant support structure with the fastener; and coupling the second portion of the infant support structure to the first engagement portion of the sleeve.

In some embodiments, the second engagement portion includes at least one radial aperture and the steps of coupling the insert to the first portion of the infant support structure with the fastener and coupling the insert to the first portion of the infant support structure with the fastener further comprise the steps of: rotating the sleeve about the insert in order to align the radial aperture of the sleeve with the at least one aperture of the insert; inserting a fastener into the at least one aperture through the radial aperture; securing the insert to the first portion of the infant support frame with the fastener; and rotating the sleeve around the insert to conceal the fastener.

According to another exemplary embodiment of the present invention, an infant support structure with a pivotable joint includes a frame, a child receiving portion, and a pivotable joint. The pivotable joint includes a first portion fixedly coupled around the frame and a second portion fixedly coupled to the child receiving portion. The first portion includes a cylindrical annulus configured to encircle the frame and the second portion includes a cylindrical portion configured to rotatably receive the cylindrical annulus, such that the cylindrical annulus of the first portion is rotatably coupled to the second portion when received therein, thereby rotatably coupling the frame to the child receiving portion.

In some embodiments of the above infant support structure the second portion further includes at least one aperture adjacent the child receiving portion and the at least one aperture is configured to receive a fastener to fixably couple the second portion to the child receiving portion.

In other embodiments, the annular cylinder includes a first end and a second end opposite the first end, a first base extending radially from the first end of the annular cylinder, a second base extending radially from the second end of the annular cylinder; and at least one aperture formed in the annular cylinder. In some of these embodiments, the cylindrical portion of the second portion also includes an opening, the at least one aperture and opening being selectively alignable. In other embodiments, the first portion includes at least one rib substantially encircling an outer face of the cylindrical annulus, the aperture and ribs collectively allowing a fastener to be received within the first portion in a position where the fastener does not contact the second portion. In still other embodiments, the first portion is formed from a first piece and a second piece, the first piece including the first base and a portion of the annular cylinder and the second piece including the second base and the remainder of the annular cylinder, and the first and second piece may be mated together.

According to yet another embodiment of the present invention, an infant support structure with a pivotable joint includes a frame, a child receiving portion, and a pivotable joint. The pivotable joint includes an annular insert including a first portion and a second portion and a sleeve. The first portion of the annular insert includes a first aperture and the second portion includes a second aperture and the first and second portion are mateable to form the annular insert. The first aperture and second aperture are linearly aligned when the first and second portion are mated together. The sleeve includes a third portion and a fourth portion, the third portion being coupleable to the child receiving portion and the fourth portion being configured to rotatably receive the insert, wherein the pivotable joint is configured to pivotally couple the child receiving portion to the frame such that the infant support structure is movable between an extended configuration and a storage configuration.

In some embodiments of this infant support structure, the sleeve also includes an opening that is selectively alignable with each of the first and second apertures and configured to allow a fastener to be inserted into each of the first and second apertures, the sleeve remaining rotatable with respect to the insert subsequent to insertion of a fastener. In other embodiments, the child receiving portion includes a softgoods support mounted on tubular rails and only the softgoods support moves when the infant support structure is moved between the extended configuration and the storage configuration.

### BRIEF DESCRIPTION OF THE DRAWINGS

FIG. 1 shows a perspective view of an exemplary embodiment of an infant support structure including a pivotable joint in accordance with the present invention

FIG. 2 shows a side perspective view of an exemplary embodiment of a first part or portion of the pivotable joint shown in FIG. 1.

FIGS. 3-8 show various perspective views of an exemplary embodiment of a second part or portion of the pivotable joint shown in FIG. 1.

FIGS. 9-13 show various perspective views of the pivotable joint of FIG. 1 in various stages of assembly.

Like reference numerals have been used to identify like elements throughout this disclosure.

### DETAILED DESCRIPTION OF THE INVENTION

Generally referring to the figures, at least one exemplary embodiment of a pivotable joint is shown. As will be discussed below in further detail, the pivotable joint includes two parts or portions: an engagement portion that may be coupled to the frame of an infant support structure and a sleeve that may rotate or pivot around, about, or within the engagement portion. Alternatively, the sleeve may be referred to as a first part or portion and the engagement portion may be referred to as the second part or portion. In use, the pivotable joint may pivotally couple the child receiving portion of a bassinet, cradle, or other child support structure to a frame or stand for that child support structure. In some embodiments, the frame or stand may be configured to allow the infant support structure to rock and the pivotable joint may securely couple the child receiving portion thereto. Preferably, the joint is configured to allow an infant support structure to easily move between an expanded configuration and a collapsed or storage configuration.

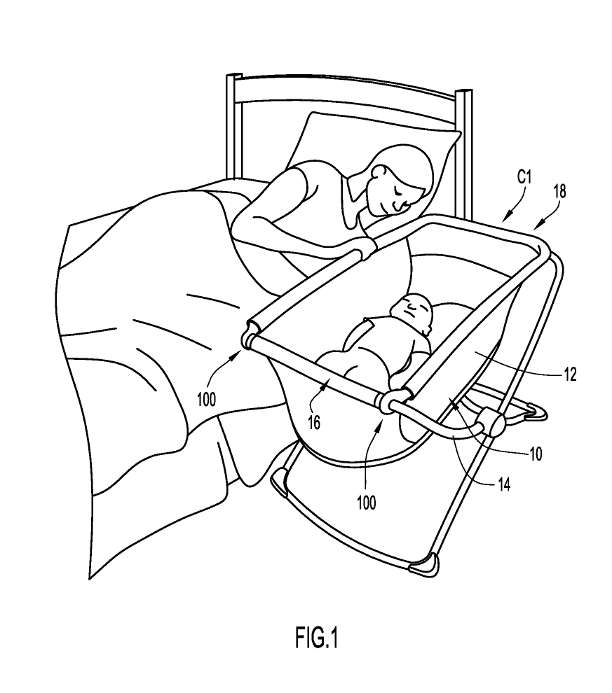

For example, and as seen in FIG. 1, a pivotable joint 100 may be installed on a rocking bassinet 10 that includes an child receiving portion 12 and a frame 14 in order to allow the bassinet 10 to move between an expanded configuration “C1” and a folded configuration (not pictured). When in the expanded configuration C1, the bassinet may be configured to receive and support a child, as seen in FIG. 1, and in the storage configuration, the frame 14 and/or child receiving portion 12 may fold or collapse onto each other in order to reduce the footprint of the bassinet and allow it to be easily stored in a closet, drawer or other such storage area. One example of such a collapsible frame is illustrated in US Patent Publication No. US 2011/0148155A1, which is incorporated by reference herein in its entirety.

In order to effectuate movement between the expanded and storage configurations, two pivotable joints 100 are installed at a first end 16 of the bassinet 10, and the two pivotable joints 100 pivotally connect the child receiving portion 12 to the frame 14. At a second and opposite end 18, the child receiving portion 12 may either rest upon the frame 14 or be removably coupled thereto. Either way, when the second end 18 of the child receiving portion 12 is free to move with respect to the frame 14, the pivotable joint 100 may allow the child receiving portion 12 to pivot with respect to/fold onto the frame 14 in order to move the bassinet 10 into its storage configuration. Additionally, the pivotable joint 100 is securely coupled to each portion—the child receiving portion 12 and the frame 14—of the bassinet 10 in order to ensure that movement between configurations is simple, repeatable, and safe.

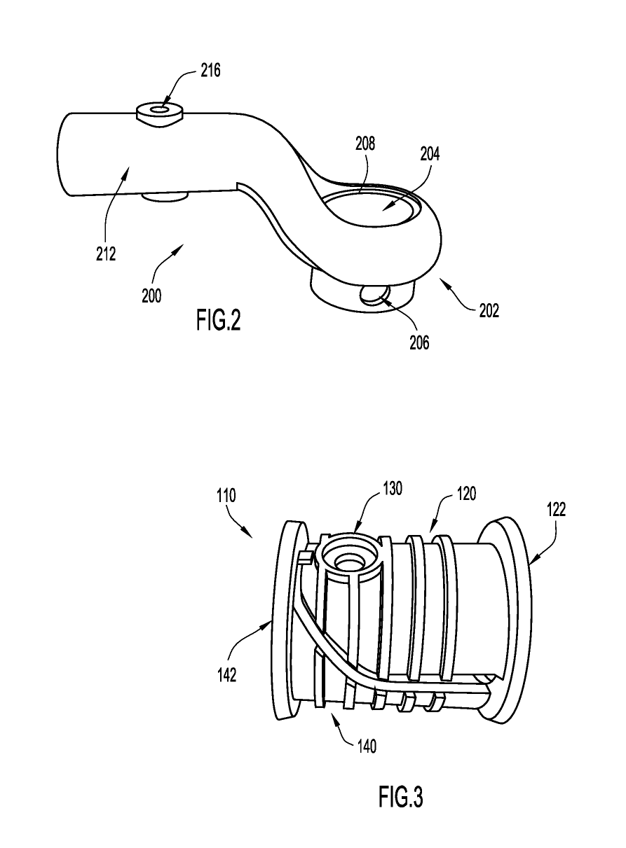

Turning now to FIGS. 2-3, a pivotable joint 100 is shown in more detail. As seen in FIGS. 2-3, pivotable joint 100 includes a sleeve 200 and an insert 110 which is insertable into and engagable with the sleeve 200. Turning specifically to FIG. 2, sleeve 200 includes two engagement portions: engagement portions 202 and 212 which are configured to be engaged with the frame 14 and child receiving portion 12, respectively. Thus, engagement portion 202 may alternatively be referred to as frame engaging portion 202 and engagement portion 212 may alternatively be referred to as child receiving portion engaging portion 212. However, in other embodiments, engagement portions 202 and 212 may each engage any portion of an infant support structure, as desired. In the particular embodiment shown in the figures, engagement portion 202 is configured to be coupled to insert 110 for rotation there between, such that when insert 110 is coupled to a portion of an infant support structure, the sleeve 200 is thereby rotatably coupled to that same portion. For example, in the embodiment seen in FIG. 1, sleeve 200 is fixedly coupled to the child receiving portion 12, insert 110 is fixedly coupled to frame 14 and, thus, sleeve 200 is rotatably coupled to frame 14.

Still referring to FIG. 2, in the embodiment shown in FIG. 2, engagement portion 212 is a cylindrical, tubular section that includes a pair of aligned apertures 216 which extends through engagement portion 212, such that a fastener may be inserted through engagement portion 212. Thus, once a portion of the child receiving portion 12 is engaged with sleeve 200, perhaps by inserting a portion of the infant support structure into an opening (not shown) included in the end of engagement portion 212, a fastener may be inserted through aligned apertures 216, such that the fastener fixedly secures the portion of the infant support structure to sleeve 200. In contrast, the frame engaging portion 202 is configured to rotatably receive the insert 110 within an opening 204. The opening 204 is surrounded by a peripheral wall 208 and includes a single aperture 206 which extends through wall 208, such that aperture 206 may allow fasteners and or tools to be passed through wall 208 and into opening 204. In some embodiments, aperture 206 allows a single fastener to be installed into insert 110 (perhaps at openings 130, 150) so that the fastener is hidden from view and/or inaccessible by a child disposed within the infant support structure.

Now referring to FIG. 3, in some embodiments, insert 110 includes two halves or portions, first portion 120 and second portion 140. Together, portions 120 and 140 form insert 110, which, in this embodiment, is a ribbed, annular, cylinder that is configured to rotatably engage engagement portion 202. As will be described in more detail below, each portion 120, 140 includes an opening 130, 150 (see FIG. 4), respectively, and openings 130, 150 may be aligned with each other when portions 120 and 140 are coupled together. Each opening 130, 150, may also include a collar 132, 152, which may restrict the size of opening 132, 152. Collars 132, 152 may, in some embodiments, be fully contained within openings 130, 150, such that they may be referred to as being countersunk or embedded within openings 130, 150. Furthermore, each portion 120, 140 includes a base 122, 142, which may alternatively be referred to as an end or side. For example, in some embodiments, base 122 may be referred to as the first base, first end or first side and base 142 may be referred to as the second base, second end, or second side.

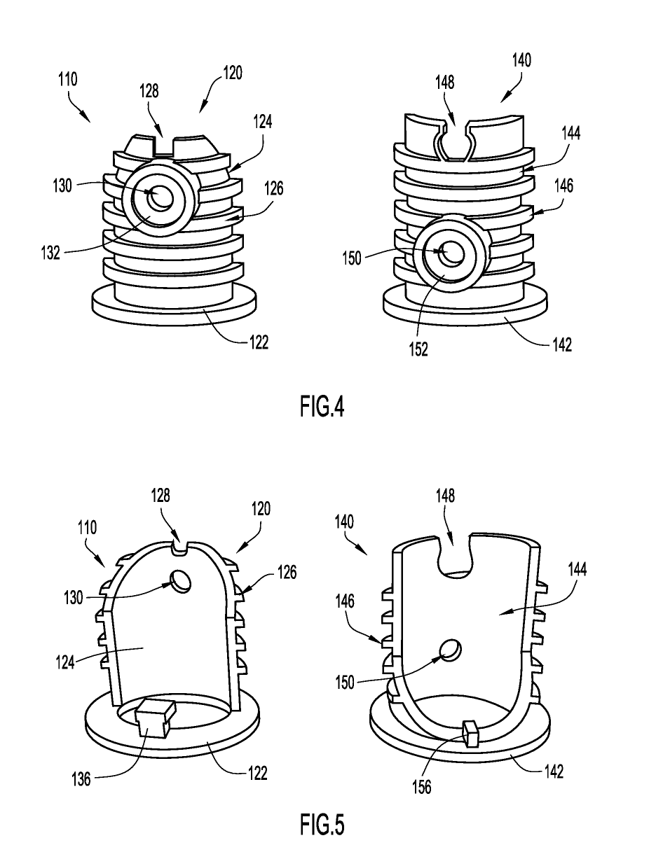

Turning next to FIGS. 4-5, the first and second portions 120, 140 are shown separated from each other. As seen best in FIG. 5, first portion 120 includes a base 122 with a protrusion 124 that extends upwards from the base 122 and second portion 140 includes a base 142 with a protrusion 144 that extends upwards from the base 142. In this particular embodiment, and as best seen in FIG. 5, the protrusions 124, 144 are a portion of cylindrical annulus and also include ribs 126, 146, respectively, on the exterior surface of protrusion 124, 144. Furthermore, each protrusion 124, 144 also includes an opening 130, 150, however opening 130 is adjacent to the distal end of protrusion 124 while opening 150 is adjacent to the proximate end of protrusion 144, insofar as distal and proximate are used with reference to the respective bases 122, 142 as oriented in FIGS. 4-5.

Still referring to FIGS. 4-5, each portion 120, 140 also includes mating or matching features which allow portions 120, 140 to be removably coupled together. Particularly, in this embodiment, portion 120 includes a slit 128 at the distal end of protrusion 124 and a tab 136 which extends from base 122 opposite from protrusion 124 (see FIG. 5). In contrast, second portion 140 includes a cavity 148 at the distal end of protrusion 144 and a knob 156 which extends from base 142 opposite from protrusion 144 (see FIG. 5).

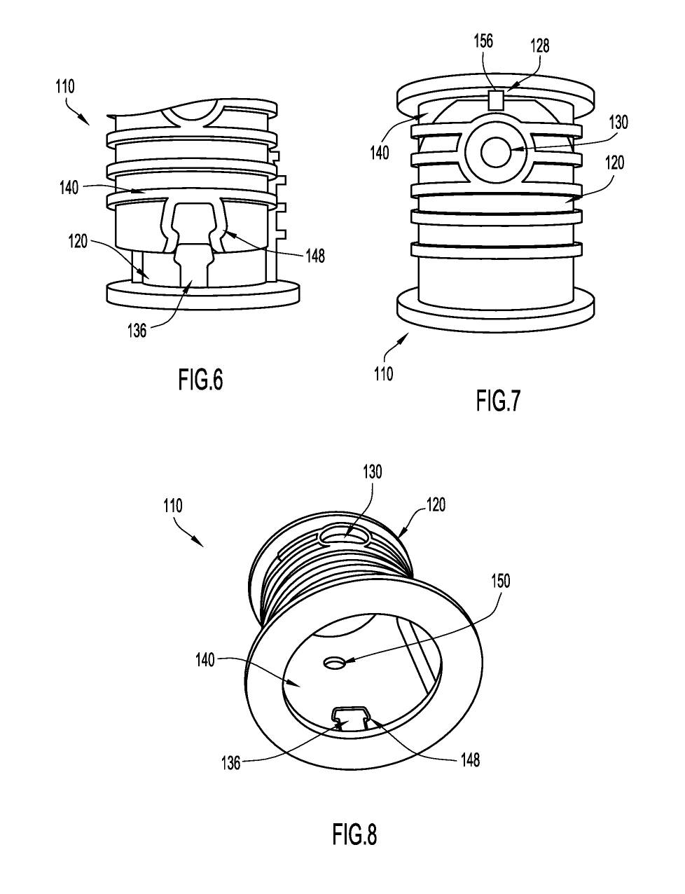

In this embodiment, and as seen in FIGS. 6-7, the knob 156 is configured to engage slit 128 (see FIG. 7) and tab 136 is configured to be secured within cavity 148 (see FIG. 6). However, in this embodiment, engaging knob 156 with slit 128, and tab 136 with cavity 148 only serve to restrict two degrees of freedom (vertical and rotational) of the two portions 120, 140 with respect to one another as oriented in FIG. 7. Thus, these mating features do not secure portions 120 and 140 together unless these features are mated or engaged with each other when portions 120 and 140 are installed within opening 204 of sleeve 200. However, when the portions are mated together within opening 204, as will be described below, the sleeve 200 serves to restrict at least one additional degree of freedom (i.e. radial and horizontal) of the two portions 120, 140 with respect to one another as oriented in FIG. 7 and, thus, allows the two portions 120, 140 to be firmly coupled together. In other embodiments, tab 136, cavity 148, knob 156, and slit 128 may simply serve to hold or key portions 120 and 140 together as an aid to assembly until a fastener can be driven through at least one of openings 130 and 150. In still other embodiments, tab 136, cavity 148, knob 156, and slit 128 may serve as indicators to ensure that a person assembling insert 110 has one portion 120 and one portion 140.

In fact, in this particular embodiment, the knob 156 and slit 128 do not restrict any motion and, instead, are merely included to ensure that portions 120 and 140 are properly aligned when portions 120, 140 are coupled together. By comparison, tab 136 has an interference or friction fit with cavity 148 which prevents portions 120 and 140 from moving longitudinally (i.e. vertically in FIG. 7) or rotationally with respect to each other but allows radial movement (i.e. movement in the z-axis of in FIG. 7) of the portions 120, 140 with respect to one another. However, in other embodiments, the first and second portion 120, 140 may include any desirable features which allow portions 120 and 140 to be securely and/or fixedly coupled together in any location, such as when portions 120, 140 are not disposed within opening 204 of sleeve 200.

Now turning to FIG. 8, portions 120 and 140 are shown coupled together and the insert 110 is shown from a bottom perspective view. As can be seen in FIG. 8, due to the aforementioned features and geometry of portions 120, 140, when portions 120, 140 are coupled together, portions 120 and 140 form a cylindrical tube, with what appears to be a single set of ribs encircling the exterior of the tube. However, in this particular embodiment, ribs 126, 146 are simply configured to align with each other such that it appears that there is only a single set of ribs. Additionally, as can be seen in FIG. 8, in this embodiment, openings 130 and 150 align when portions 120 and 140 are coupled together, such that a fastener or rod could be inserted therethrough.

Although the features of portions 120 and 140 align in this embodiment, in other embodiments portions 120 and 140 may include any desirable alignment or misalignment consistent with the scope of this invention. However, in preferred embodiments, the openings 130, 150 are at least vertically aligned, insofar as they are both the same distance from bases 122, 142, such that when insert 110 is disposed within opening 204, rotation of the insert 110 can align either opening 130, 150 with aperture 206. Additionally, in preferred embodiments, the ribs 126, 146 may or may not align, but the ribs 126, 146 will be configured to extend away from protrusions 124, 144 an amount which allows them to contact the interior face of wall 208. Thus, ribs 126, 146 function as stand-offs which allow insert 110 to fit tightly (although not tight enough to prevent rotational movement) within opening 204 and not wobble or tilt while disposed therein.

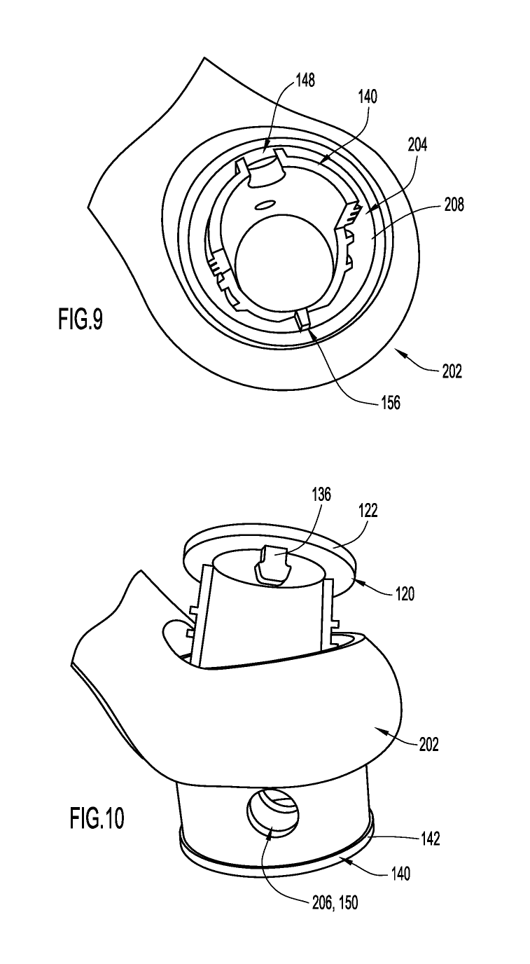

Referring next to FIGS. 9-13, the insert 110 is shown being inserted within the sleeve 200. In FIG. 9, second portion 140 has been inserted (from beneath opening 204) into opening 204. Once portion 140 is positioned, at least partially, within opening 204, the first portion 120 may be inserted into opening 204 (from above opening 204), as shown in FIG. 10, until the tab 136 is secured within cavity 148. When portions 120, 140 are within opening 204 and tab 136 is secured within cavity 148, as shown in FIG. 11, the insert 110 will be rotatably secured within opening 204, such that it may only move rotationally, in either direction, in accordance with dual-headed directional arrow D1. In order to ensure that the insert 110 is securely held within opening 204, the insert 110 may be sized such that bases 122, 142 slightly protrude from either end of opening 204 and extend over a portion of wall 208. In this particular embodiment, the bases 122, 142 of portions 120 and 140 are sized as such and, thus, prevent insert 110 from sliding longitudinally within opening 204.

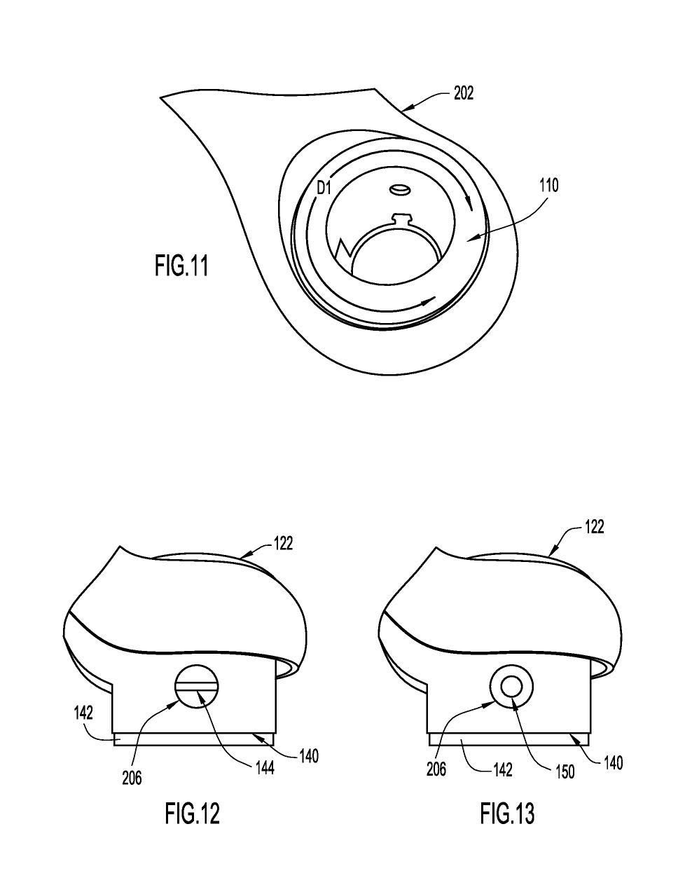

Finally, as shown in FIGS. 12-13, when the insert 110 is rotatably mounted within the sleeve 200, it may be rotated to selectively align the openings 130, 150 with aperture 206. Rotating at least one of the openings 130, 150 into alignment with opening 206 may allow a user to insert a fastener, such as a screw, through sleeve 200 (via aperture 206) and into opening 130 and/or 150. However, since openings 130, 150 include collars 132, 152, respectively, a fastener may sit within opening 130, 150, once it is inserted therein, instead of passing therethrough (allowing the fastening of insert 110 directly to the frame 14). Additionally, in some embodiments, the collars 132, 152 may be embedded or countersunk within openings 130, 150, such that a fastener can sit thereon without protruding or extending past the exterior bounds of insert 110. The fastener may also be further protected from extending beyond the exterior bounds of insert 110 by the inclusion of ribs, such as ribs 126, 146, which extend outward from protrusions 124, 144. Thus, in some embodiments, collars 132, 152 and ribs 126, 146 may collectively ensure that a fastener for securing insert 110 directly to the frame 14 inserted into openings 130, 150 does not extend beyond the exterior bounds of insert 110 and, thus, does not prevent or deter the opening 204 from being rotatable with respect to insert 110. Additionally, and as mentioned above, these features may also allow any fastener installed in insert 100 to be hidden from view or access by being rotated out of alignment with aperture 206.

In use, the first and second portions 120, 140 may first be inserted into opposite ends of opening 204 and secured together while disposed therein. Then, a tube or portion of a frame 14 may be inserted within or through the insert 110. A user may then rotate the insert 110 until one of the openings 130, 150 aligns with opening 206, thereby allowing a user to install a fastener into insert 110 and through the inserted portion of frame 14. The user may keep the opening 130, 150 aligned with opening 206 until the fastener is fully installed and coupling the insert 110 to the portion of the frame 14 inserted therethrough. Once the insert 110 is coupled to the frame 14, insert 110 will remain in a fixed position with respect to the frame 14, but the sleeve 200 will remain free to rotate about the insert 110. Thus, when the sleeve 200 is coupled to a child receiving portion 12 of a child support structure 10, the child receiving portion 12 will be both securely and rotatably coupled to the frame 14 via the pivotable joint 100.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A pivotable joint for an infant support structure comprising:
an insert fixedly coupleable to a first portion of an infant support structure;
a sleeve including a first engagement portion and a second engagement portion, the sleeve being fixedly coupled to a second portion of the infant support structure via the first engagement portion and the insert being rotatably mounted within the second engagement portion; and
a fastener configured to couple the insert to the first portion of the infant support structure, wherein the fastener is disposed entirely interiorly of the second engagement portion.

2. The pivotable joint of claim 1, wherein the infant support structure is a bassinet and the pivotable joint allows the bassinet to move between an expanded configuration and a folded configuration.

3. The pivotable joint of claim 1, wherein the insert comprises an annular cylinder including at least one aperture formed in the outer surface of the annular cylinder.

4. The pivotable joint of claim 3, wherein the annular cylinder includes exterior ribs, the ribs configured to space the insert from the sleeve while allowing the insert and sleeve to rotate with respect to each other.

5. The pivotable joint of claim 3, wherein the annular cylinder is formed from a first portion and a second portion configured to be mated together.

6. The pivotable joint of claim 5, wherein the second engagement portion includes an interior opening, the first portion includes a first base, and the second portion includes a second base, the first base being configured to extend beyond the periphery of the interior opening at a first end of the interior opening and the second base being configured to extend beyond the periphery of the interior opening at a second end of the interior opening to longitudinally secure the insert within the sleeve.

7. The pivotable joint of claim 5, wherein the first portion includes at least one of the at least one aperture, the second portion includes at least one of the least one apertures and the apertures are configured to be linearly aligned when the first portion is mated to the second portion.

8. The pivotable joint of claim 3, wherein the second engagement portion includes at least one radial aperture, the radial aperture being selectively alignable with at least one of the at least one aperture included on the insert to allow the fastener to pass through the sleeve and engage the insert.

9. The pivotable joint of claim 8, wherein the diameter of the at least one aperture included on the insert is less than the diameter of the radial aperture such that the fastener may pass through the radial aperture but be retained in the aperture.

10. A method of installing the pivotable joint of claim 5 onto an infant support structure comprising the steps of:
inserting the first portion of the insert into a first end of the second engagement portion of the sleeve;
inserting the second portion of the insert into a second end of the second engagement portion of the sleeve;
mating the first portion to the second portion;
inserting the first portion of the infant support structure through the insert;
coupling the insert to the first portion of the infant support structure with the fastener; and
coupling the second portion of the infant support structure to the first engagement portion of the sleeve.

11. The method of claim 10, wherein the second engagement portion includes at least one radial aperture and the steps of coupling the insert to the first portion of the infant support structure with the fastener and coupling the insert to the first portion of the infant support structure with the fastener further comprise the steps of:
rotating the sleeve about the insert in order to align the radial aperture of the sleeve with the at least one aperture of the insert;
inserting a fastener into the at least one aperture through the radial aperture;
securing the insert to the first portion of the infant support frame with the fastener; and
rotating the sleeve around the insert to conceal the fastener.

12. An infant support structure with a pivotable joint, comprising:
a frame;
a child receiving portion;
a pivotable joint comprising:
a first portion fixedly coupled around the frame, the first portion including an cylindrical annulus configured to encircle the frame; and
a second portion fixedly coupled to the child receiving portion, the second portion including a cylindrical portion configured to rotatably receive the cylindrical annulus, such that the cylindrical annulus of the first portion is rotatably coupled to the second portion when received therein, thereby rotatably coupling the frame to the child receiving portion.

13. The infant support structure of claim 12, wherein the second portion further comprises:
at least one aperture adjacent the child receiving portion, the at least one aperture configured to receive a fastener to fixably couple the second portion to the child receiving portion.

14. The infant support structure of claim 12, wherein the annular cylinder further comprises:
a first end and a second end opposite the first end;
a first base extending radially from the first end of the annular cylinder;
a second base extending radially from the second end of the annular cylinder; and
at least one aperture formed in the annular cylinder.

15. The infant support structure of claim 14, wherein the cylindrical portion of the second portion further comprises:
an opening, the at least one aperture and opening being selectively alignable.

16. The infant support structure of claim 14, wherein the first portion further comprises:
at least one rib substantially encircling an outer face of the cylindrical annulus, the aperture and ribs collectively allowing a fastener to be received within the first portion in a position where the fastener does not contact the second portion.

17. The infant support structure of claim 14, wherein the first portion is formed from a first piece and a second piece, the first piece including the first base and a portion of the annular cylinder and the second piece including the second base and the remainder of the annular cylinder, wherein the first and second piece may be mated together.

18. An infant support structure with a pivotable joint, comprising:
a frame;
a child receiving portion; and
a pivotable joint comprising:
an annular insert including a first portion and a second portion, the first portion including a first aperture and the second portion including a second aperture, wherein the first and second portion are mateable to form the annular insert and the first aperture and second aperture are linearly aligned when the first and second portion are mated together; and
a sleeve, the sleeve including a third portion and a fourth portion, the third portion being coupleable to the child receiving portion and the fourth portion being configured to rotatably receive the insert, wherein the pivotable joint is configured to pivotally couple the child receiving portion to the frame such that the infant support structure is movable between an extended configuration and a storage configuration.

19. The infant support structure of claim 18, wherein the sleeve further comprises:
an opening that is selectively alignable with each of the first and second apertures and configured to allow a fastener to be inserted into each of the first and second apertures, the sleeve remaining rotatable with respect to the insert subsequent to insertion of a fastener.

20. The infant support structure of claim 18, wherein the child receiving portion includes a softgoods support mounted on tubular rails and only the softgoods support moves when the infant support structure is moved between the extended configuration and the storage configuration.
